(19) United States
(12) Patent Application Publication
(10) Pub. No.: US 2024/0202703 A1
(43) Pub. Date: Jun. 20, 2024

(54) SYSTEM AND METHOD FOR BLOCKCHAIN TRANSACTION MANAGEMENT

(71) Applicant: Hathor Labs, George Town (KY)

(72) Inventors: Marcelo Salhab Brogliato, Frisco, TX (US); Yan Martins, Lisbon (PT); Trond Bjoroy, Klokkarvik (NO)

(73) Assignee: Hathor Labs, George Town (KY)

(21) Appl. No.: 18/537,643

(22) Filed: Dec. 12, 2023

Related U.S. Application Data
(60) Provisional application No. 63/432,782, filed on Dec. 15, 2022.

(51) Int. Cl. G06Q 20/36; G06Q 20/38

(52) U.S. Cl. CPC G06Q 20/367; G06Q 20/3825; G06Q 20/389

(57) ABSTRACT

In variants, the method can include: receiving a set of cryptographically signed blockchain transactions, matching the cryptographically signed blockchain transactions, wherein different transactions can include different cryptographic asset types, and executing an atomic asset swap using the matched cryptographically signed blockchain transactions on a blockchain. In examples, the different cryptographic asset types can be from different blockchains.

### CROSS-REFERENCE TO RELATED APPLICATIONS

This application claims the benefit of U.S. Provisional Application No. 63/432,782 filed 15 Dec. 2022, each of which is incorporated in its entirety by this reference.

### TECHNICAL FIELD

This invention relates generally to the cryptographic field, and more specifically to a new and useful system and method for blockchain transaction management in the cryptographic field.

### BRIEF DESCRIPTION OF THE FIGURES

FIG. 1 is a schematic representation of a variant of the system.

FIG. 2 is a schematic representation of data transfer between components of a variant of the system.

FIG. 3 is a schematic representation of a variant of the method.

FIG. 4 is a schematic representation of a variant of the method, where the users sign partial transactions.

FIG. 5 is schematic representation of an example of a variant of the method, where the users each sign a transaction generated based on the matched orders.

FIG. 6 is schematic representation of an example of a variant of the method, where a first user partially signs a transaction generated based on the matched orders, and a second user fully signs the partially-signed transaction.

FIG. 7 is a schematic representation of an example of a variant of the method, where the orders include partial transactions that are presigned by the users, and wherein the partially signed transactions are aggregated into a full transaction when the orders are matched.

FIG. 8 is a schematic representation of an example of a variant of the method, where users create and sign partial transactions, which are matched thereafter by the exchange system.

FIG. 9 is an illustrative example of orders and transactions.

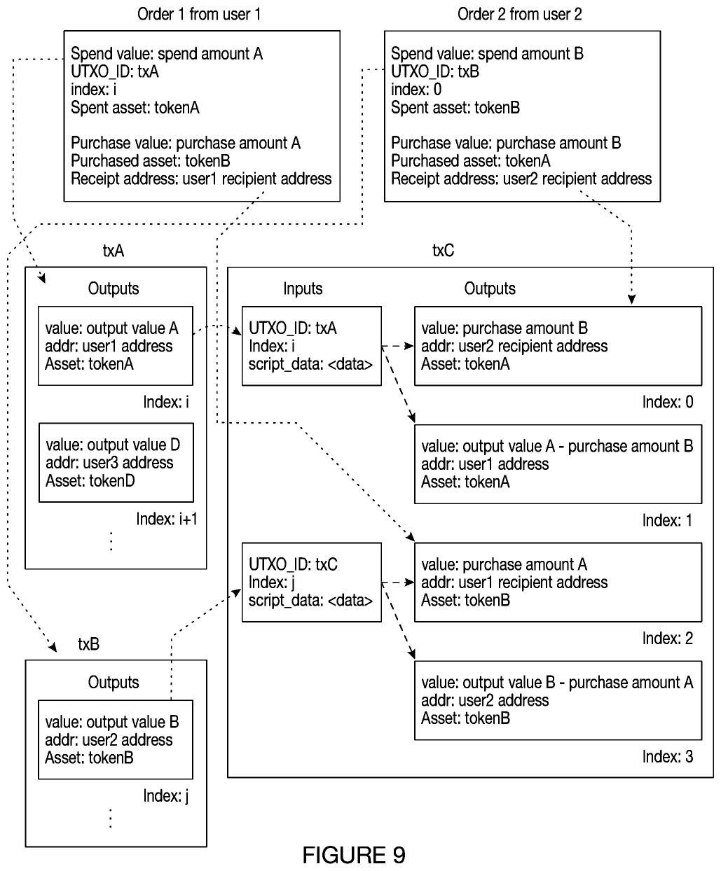

FIG. 10 is an illustrative example of the usage of a SIGHASH flag to sign a transaction using a bitmask.

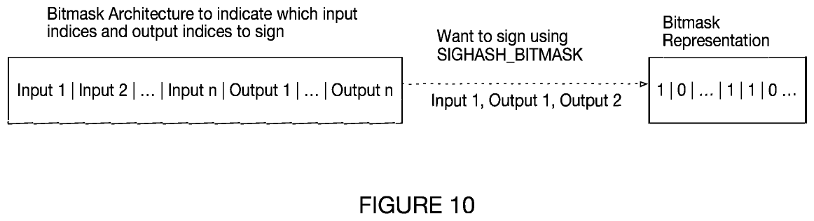

FIG. 11 is an illustrative example of orders and transactions, wherein different SIGHASHES are displayed to provide signed information.

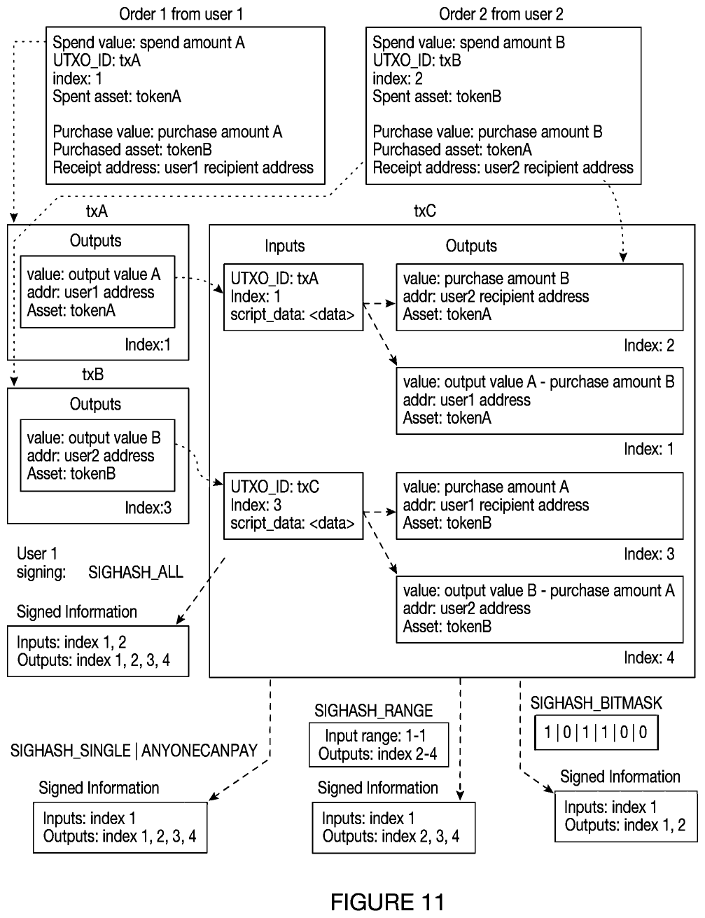

FIG. 12 is an illustrative example of orders and transactions, wherein the transaction is signed with a bitmask and the partial signature is sent to the blockchain with the relevant information.

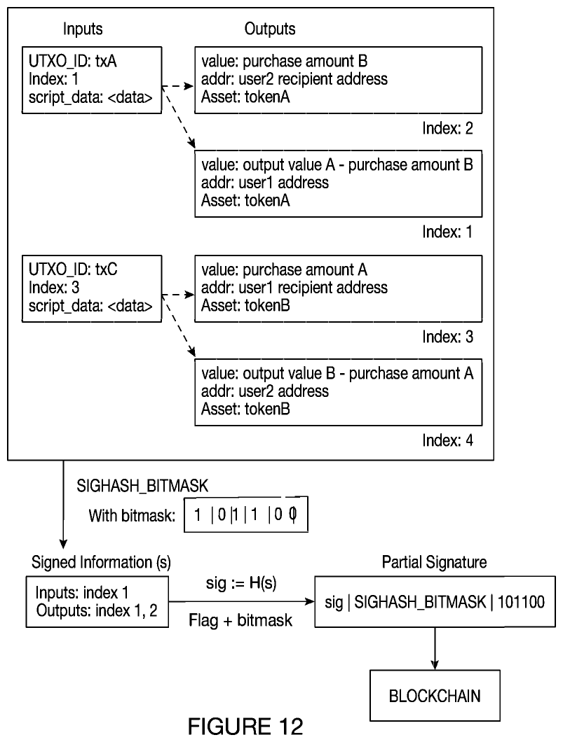

FIG. 13 is an illustrative example of blockchain validation, wherein the blockchain receives a partial signatures from each of two users.

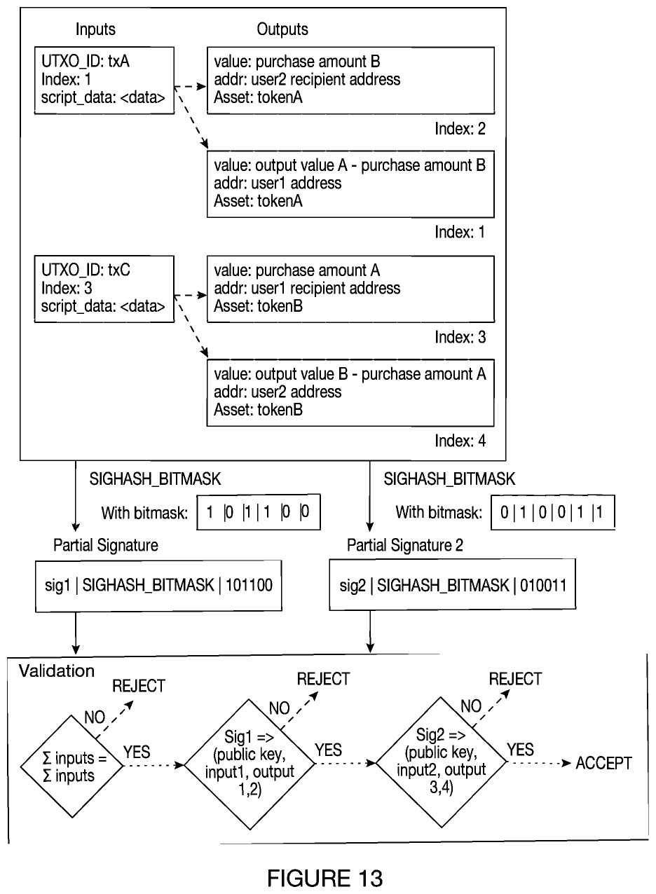

### DETAILED DESCRIPTION

The following description of the embodiments of the invention is not intended to limit the invention to these embodiments, but rather to enable any person skilled in the art to make and use this invention.

### 1. Overview

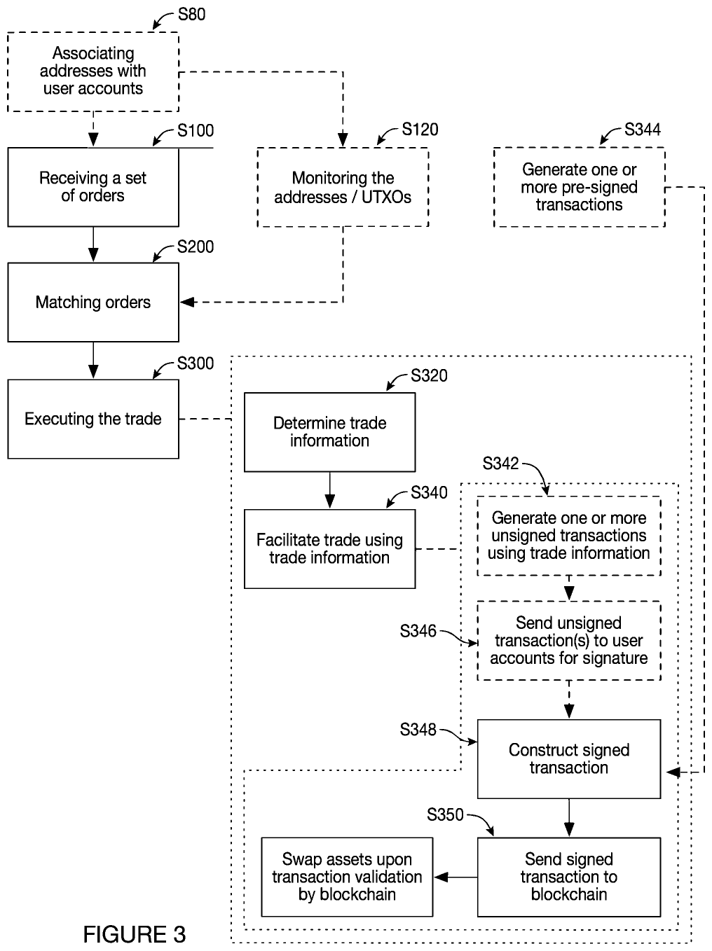

As shown in FIG. 3, variants of the exchange method can include: receiving a set of orders, matching orders, and executing a trade based on the matched orders. The method can function to exchange one or more cryptographic asset types (e.g., native assets, assets from other blockchains, etc.) between a set of users using an atomic swap (e.g., a single blockchain transaction) in a noncustodial manner.

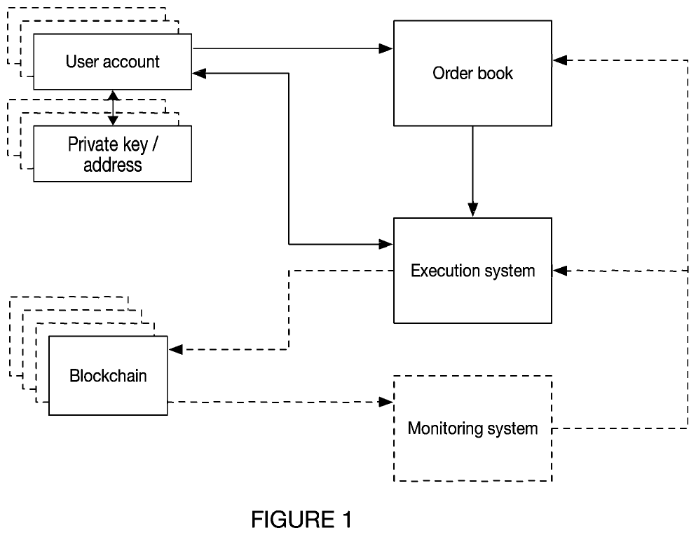

In variants, the method can be performed by one or more exchange systems. As shown in FIG. 1, variants of the exchange system can include: an order book, a monitoring system, and an execution system interfacing with a set of blockchains and addresses. The exchange system can function to facilitate cryptographic asset trades in a noncustodial manner.

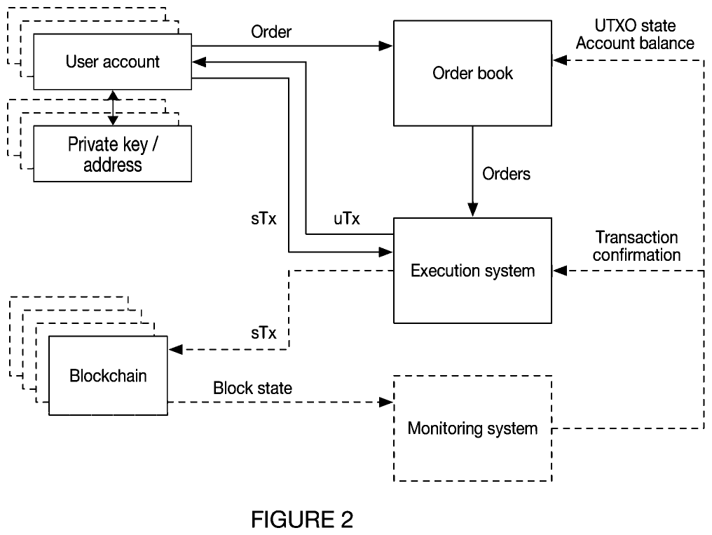

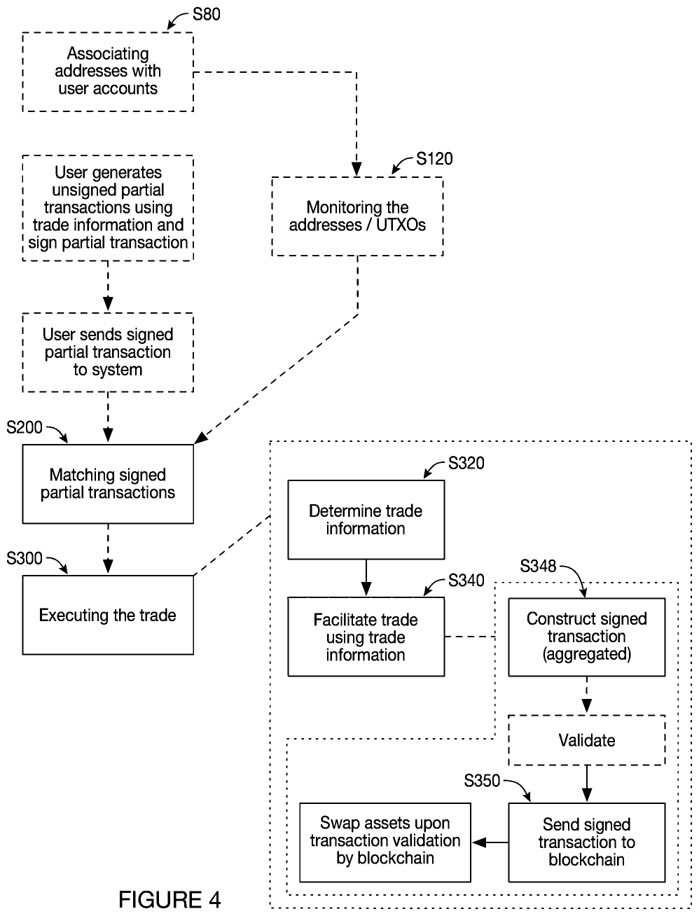

In an example, the exchange system can include a centralized order book (e.g., an offchain order book) that tracks and matches orders from a set of user accounts, a monitoring system that tracks the user address balance and/or the UTXO state associated with each user account, and an execution system that executes orders (e.g., on-chain) when the orders are matched (e.g., examples shown in FIG. 2 and FIG. 4).

In an example, the method can include: receiving an order from a user account, wherein the order can identify the asset types and amounts to exchange, the blockchain address holding said assets (e.g., sending account, sold UTXO, etc.), the asset types and amounts to purchase, the recipient address to send the purchased assets to, the time in force, and/or other trade instructions. The assets are preferably represented as UTXOs (e.g., unspent transaction outputs), but can be otherwise represented. Address and/or UTXO ownership can optionally be verified before the order is listed on the order book, such as by verifying a signature generated by the private key (e.g., on a verification message, on the order, etc.). The UTXOs and/or addresses associated with live orders can be monitored (e.g., to verify that they are not spent and/or to verify that the account has sufficient funds to cover the order). When two orders are matched, the execution system can facilitate order settlement. In variants, the execution system can generate one or more unsigned transactions (uTx) for the trade, sending the spend assets to the other party's recipient address; send the unsigned transaction(s) to each user (e.g., wallet); optionally receive signed transactions (sTx) from the respective users (e.g., wallet); optionally verify the signatures; and optionally send the signed transactions to the respective blockchains. The method can optionally periodically send false order settlement transactions (e.g., false transactions, false partial transactions) to the users to sign (e.g., to prevent the user from selectively signing real settlement orders), wherein the system informs the user of the order validity after signature receipt.

In another example, the method can include: receiving a set of orders from a set of users, wherein each order can include a partially signed transaction (e.g., signed using the user's private key and a SIGHASH bitmask that selects portions of the transaction associated with the user); matching the orders; and constructing a valid, signed transaction based on the partially signed transactions from the matched orders. In this example, the signed transaction can be constructed while the respective wallets (e.g., private keys) are offline, without signature generation after order matching and/or transaction construction (e.g., without an additional round of signing after order matching). In examples, the signatures for the partially signed transactions can be generated based on a subset of all inputs (e.g., one or more inputs) and/or a subset of all outputs (e.g., one or more outputs), wherein the signed inputs and outputs can have the same or different index. In a specific example, none of the signatures for the signed transaction are generated based on the full transaction (e.g., based on all inputs and all outputs for the transaction; no signatures are generated using SIGHASH_ALL; etc.).

In these examples, the order settlement can be performed on-chain. In a first example, the order is settled (e.g., the assets are exchanged) using an atomic swap (e.g., a single transaction). In this example, the assets are exchanged when the blockchain validates the transaction. The blockchain can validate the transaction when the total asset input values match the total asset output values, when the signatures are valid for the transaction (e.g., for the entire transaction; for portions of the transaction associated with the signature, as identified by the sighash type, etc.), when the signatures collectively sign all inputs and all outputs of the transaction, when the transaction conditions are satisfied (e.g., the transaction does not exceed a maximum number of orders, maximum number of inputs, maximum number of outputs, etc.; the transaction is validated before a specified block height; etc.), and/or when any other suitable set of conditions are met. In an illustrative example, the order is settled (e.g., the assets are exchanged) by using an atomic swap on the Hathor network, wherein different asset types (e.g., native tokens, wrapped tokens, wrapped assets, etc.) and quantities can be swapped between parties in a single transaction or operation (e.g., wherein the transaction(s) in the operation are signed by the respective sending parties). In a second example, when all assets in the orders are on the same account-based network, the assets can be swapped using an atomic swap smart contract (e.g., the assets are sent to the smart contract address, and the smart contract releases the assets to the receiving parties when the exchange condition is met). In a third example, assets can be exchanged cross-network using a hashed timelock contract (HTLC). However, the trade can be otherwise settled.

### 2. Technical Advantages

In variants, the technology can confer several advantages over conventional systems, such as centralized or decentralized exchanges.

First, variants of the technology can enable better security by enabling users to custody their own assets, thus removing the need for users to transfer their assets to the exchange, a third party custodian, or a smart contract for custodying.

Second, variants of the technology can enable better privacy, since no external party (aside from the user) knows which addresses are owned by the user. While the other party in the trade will know the receipt address for the user, the other party in the trade will not have knowledge of other addresses for the user.

Third, variants of the technology can enable better throughput and scalability by leveraging a centralized, offchain order book.

Fourth, variants of the technology can utilize a decentralized order book, which can remove dependencies on a centralized system (e.g., remove dependence on centralized system uptime, availability, speed, latency, etc.).

Fifth, variants of the technology enable an execution of an atomic swap, swapping different assets, optionally across different blockchains, in a single transaction. This enables greater asset flexibility and fewer transaction costs.

Sixth, variants of the technology enable cryptographic asset orders to be matched and settled without additional wallet involvement after initial order placement. This can result in better security, since the wallets—and associated private keys—can be kept offline (e.g., in cold storage) and do not need to be online (e.g., “hot”) for the transaction to be completed. This can decrease the probability of—and/or entirely remove—a potential attack vector for private key theft.

However, further advantages can be provided by the system and method disclosed herein.

### 3. System

As shown in FIG. 1, the exchange system can include an order book, a monitoring system, and an execution system, but can additionally or alternatively include any other suitable set of components. The exchange system functions to facilitate asset exchanges between users.

All or parts of the exchange system can execute on one or more computing environments. Examples of computing environments that can be used include: virtual machines, bare metal machines, user space instances (e.g., containers), cloud services, and/or any other suitable computing environment. All or portions of the exchange system can be centralized or decentralized. All or portions of the exchange system can be executed on-chain (e.g., using a smart contract) or off-chain.

The exchange system preferably has a single version for each set of users (e.g., to prevent trade or state conflicts), but can alternatively have multiple versions. The exchange system can have one or more instances (e.g., duplicates, backups, etc.).

The exchange system can interface with and/or use one or more blockchains. The blockchains can be: UTXO-based chains, account-based chains, hybrid chains, and/or any other suitable blockchain. Examples of blockchains can include: Ethereum, Bitcoin, Hathor, and/or any other suitable chain.

The exchange system can interface with one or more blockchain addresses. Each blockchain address can be associated with a user, and each user can be associated with one or more blockchain addresses on one or more blockchains. A user can own or control an address when they have access to the private key associated with the address (e.g., used to generate the blockchain address, used to generate valid cryptographic signatures associated with the address, etc.). For example, a user can have a spend address that holds an asset to spend, and a receipt address that receives purchased assets. The spend and receipt addresses can be on the same or different blockchains. The spend and receipt addresses are preferably specific to the spent and purchased assets, respectively, but can alternatively be shared across different assets. Each address can be associated with a balance and/or a set of UTXOs (e.g., unspent transaction outputs), which can be determined based on the historical chain of confirmed blocks from the blockchain. The addresses (and/or private keys associated with the addresses) for a user or set thereof can be managed by a wallet or other system.

The order book of the exchange system functions to create, edit, cancel, track, and otherwise manage orders from a set of user accounts or wallets. The exchange system preferably includes a single order book, but can alternatively include multiple order books (e.g., for different jurisdictions, different user sets, different asset pairs, etc.). The order book is preferably off-chain, but can alternatively be on-chain (e.g., implemented by a smart contract). The order book is preferably centralized (e.g., managed by a single entity, by a single computing system, etc.), but can alternatively be decentralized (e.g., managed by a distributed system, managed by a mesh system, maintained using a consensus protocol, maintained by the nodes of the blockchain validating the transactions, maintained by a secondary blockchain, etc.). The order book preferably does not custody assets, but may alternatively custody assets.

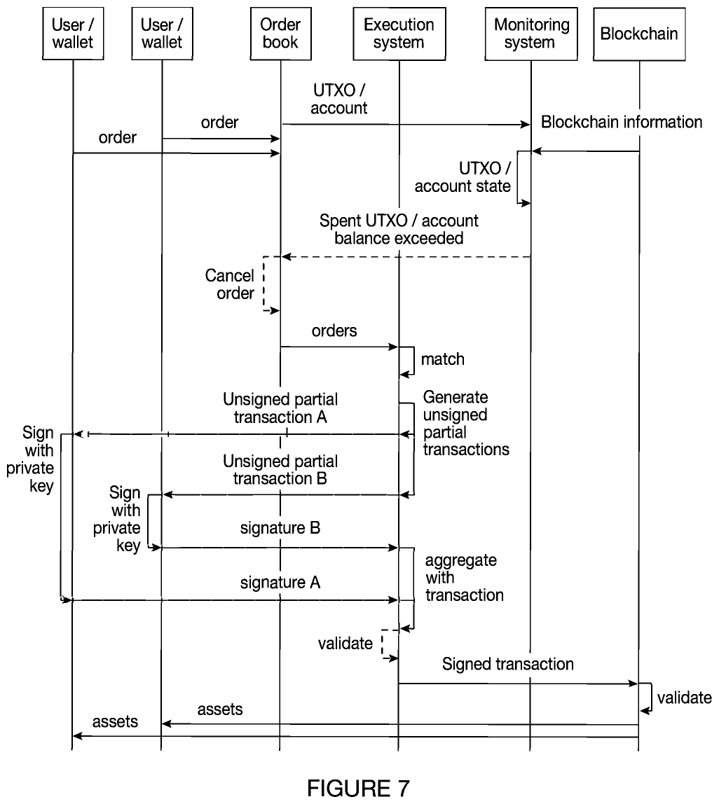

The orders in the order book can include: buy orders, sell orders, trade orders, and/or other orders. Each order can include: a first asset identifier (e.g., spent asset); first asset amount (e.g., bid price, ask price); an identifier for the first asset token to be spent in exchange for the second asset (e.g., the UTXO's transaction identifier, index value, etc.); a second asset identifier (e.g., purchased asset); second asset amount (e.g., number of tokens of the second asset to be purchased); a source address (e.g., holding the first asset); a receipt address (e.g., to receive the second asset); blockchain fee limits (e.g., the maximum gas or other blockchain fee the user is willing to pay); exchange fees; a set of trade instructions; and/or any other suitable order information (e.g., example shown in FIG. 7). The set of trade instructions can include: order type (e.g., market order, limit order, etc.), time in force, conditions (e.g., stop order, peg order, market-if-touched order, one cancels other orders, one sends other orders, at the opening orders, etc.), transaction conditions (e.g., minimum or maximum number of inputs in a transaction, minimum or maximum number of outputs in a transaction, minimum or maximum number of orders used to construct a transaction, minimum or maximum number of signatures per transaction, etc.), and/or other instructions. The time in force can be: a wall-clock time (e.g., number of hours, number of days, etc.), a block height time (e.g., must be validated before a predetermined block height, must be validated after a predetermined block height, etc.), and/or otherwise defined. The order can be a bid order identifying a bid asset (e.g., the purchased asset that the buyer wants to purchase), a bid price (e.g., price that the buyer is willing to pay for the purchased asset, in units of a spent asset), and a bid amount (e.g., number of purchased assets the buyer wants to buy); an ask order identifying an ask asset (e.g., asset that a seller wants to sell), an ask price (e.g., price that the seller is willing to take for the spent asset, in units of the purchased asset), and an ask amount (e.g., number of spent assets that the seller wants to sell); and/or any other suitable order. The orders can be signed by the user's private key (e.g., associated with the spend address), be associated with a proof of knowledge (e.g., a zero knowledge proof that the order is signed, a proof that the order was submitted by an owner of sufficient assets, etc.), or left unsigned. In a first variant, an order can be signed fully, where all the inputs and outputs of the order are signed together. In a second variant, an order can be signed partially, where a user can sign at least one of their own input and all outputs, at least one of their own input and no outputs, or at least one of their own input and the output with the same identifier. In a third variant, an order can be signed partially, wherein a user can sign one or more inputs and one or more outputs (e.g., dynamically selected using a predetermined or customizable bitmask, using a set of input and output indices regardless of a shared identifier, etc.).

Each order can be received from and/or otherwise associated with a user account. A user account can be associated with a user (e.g., via a user identifier, such as an email address). Each user account can be associated with one or more addresses and/or other blockchain identifier. Each address can be associated with a private key (e.g., be derived from the private key, be derived from a public key paired with the private key, etc.). Each private key can be associated with one or more addresses. Each private key can be used to sign transactions from the associated addresses (e.g., generate a valid cryptographic signature for a transaction involving assets held by the respective address).

In variants, the system can verify user account association with a blockchain address (e.g., identified in an order, submitted by the user during signup, etc.) before allowing trades involving the address (e.g., require proof of ownership). User account association with the address can be verified by sending the user account a verification message for signature with the private key associated with the address, then validating the signature on the validation message, or otherwise verified.

In variants, the order book can optionally match orders; alternatively, a matching system can match the orders from the order book. The orders are preferably matched using a matching algorithm, such as a price/time algorithm (e.g., first in first out), pro-rata algorithm, and/or other algorithm. In a first example, two or more orders exchanging the same assets (e.g., for collectively reciprocal amounts) can be matched. In an illustrative example, an order exchanging 5 token A for 4 token B can be matched with an order exchanging 4 token B for 5 token A, or be matched with an order exchanging 2 token B for 3 token A and an order exchanging 2 token B for 2 token A. In a second example, two or more partial transactions exchanging the same assets (e.g., for collectively reciprocal amounts) can be matched. In an illustrative example, a partial transaction exchanging 5 token A for 4 token B can be matched with an order exchanging 4 token B for 5 token A, or be matched with an order exchanging 2 token B for 3 token A and an order exchanging 2 token B for 2 token A. However, the orders can be otherwise matched.

The matching system (or other system) can optionally select UTXOs from the spend account identified in the order for a UTXO-based asset, wherein the selected UTXO can have a value closest to the overall price of the trade, be a UTXO that will not result in dust after the trade, and/or otherwise selected.

However, the order book can be otherwise configured.

The monitoring system of the exchange system functions to monitor address balances (e.g., example shown in FIG. 4). The monitoring system can be executed on the same or different computing environment as the other components of the exchange system. The exchange system can include one or more monitoring systems (e.g., for different jurisdictions, user sets, blockchains, redundancy, etc.). The monitoring system can be centralized or decentralized (e.g., executed by a distributed system, executed by a mesh system, executed using a consensus protocol, executed by the nodes of the blockchain validating the transactions, executed by a secondary blockchain, etc.). The monitoring system can monitor the balance (e.g., state) of: all addresses, only the addresses associated with pending orders, only the UTXOs associated with pending orders, only the addresses associated with user accounts (e.g., validated by the system, registered with the system, etc.), only the UTXOs associated with said addresses, and/or any other suitable set of information. The monitoring system preferably monitors the addresses and/or UTXOs on all blockchains supported by the exchange system, but can alternatively monitor the addresses on a subset of the blockchains, and/or monitor any other suitable set of blockchains. The monitoring system preferably monitors the addresses by running nodes of the monitored blockchains, but can alternatively retrieve the address states from a third party system and/or otherwise monitor the address state. In an illustrative example, the monitoring system can verify that a UTXO identified in an order is unspent before allowing the order to be submitted to the order book. In a second illustrative example, the monitoring system can flag a pending order as invalid when a UTXO identified in the order is spent (e.g., the UTXO is used as an input into a confirmed transaction in a block of the blockchain).

However, the monitoring system can be otherwise configured and operated.

The execution system of the exchange system functions to facilitate the asset exchange after orders have been matched. For example, the exchange system can generate unsigned transactions based off matched order information, interact with users and/or wallets to obtain signatures for the transactions, verify signatures, aggregate signatures with the respective transactions, aggregate partially signed transactions from matched orders, send signed transactions to the blockchain, monitor transaction status, verify transaction validation, and/or perform other actions. Additionally or alternatively, other subsystems (e.g., the wallets, order book, etc.) can perform these functionalities. The exchange system can be a separate entity from the order book, be consolidated into single system, or otherwise configured. The exchange system can include a single execution system (e.g., for multiple blockchains, for multiple asset pairs, etc.), multiple execution systems (e.g., for different jurisdictions, user sets, blockchains, asset pairs, etc.), and/or any other suitable number of execution systems. The execution system preferably does not custody assets (e.g., does not custody assets in a smart contract, does not have a third party custody asset, etc.), but can alternatively custody assets. The execution system can be executed on the same or different computing environment as the other components of the exchange system. The execution system can be centralized or decentralized (e.g., executed by a distributed system, executed by a mesh system, executed using a consensus protocol, executed by the nodes of the blockchain validating the transactions, executed by a secondary blockchain, etc.). Alternatively, the system can omit an execution system. The execution system preferably handles UTXOs, but can additionally or alternatively handle account-based assets, and/or handle any other suitable type of cryptographic asset.

However, the execution system can otherwise facilitate exchange settlement.

In variants, the execution system can optionally send false transactions (e.g., using the user's order information) to the user for signature and notifying the user that the transaction was false after signature, which can obfuscate which transaction is a true transaction until after the transaction is signed. This can prevent users from selecting which transactions to sign. The false transactions can be sent at a predetermined frequency, randomly, and/or at any other suitable time.

In variants, the execution system can optionally add fees (e.g., exchange fees, blockchain fees, etc.). The fees can be included in the unsigned transactions, be billed through a separate channel (e.g., in fiat, through the user account), and/or otherwise obtained.

However, the execution system can be otherwise configured.

The exchange system can additionally or alternatively be used with: a set of blockchain nodes, a set of wallets, a set of cryptographic assets, and/or other components.

A blockchain node functions to interact with a blockchain. For example, the blockchain node can: send transactions to the blockchain, validate transactions, synchronize blocks from the blockchain, and/or perform other blockchain functionalities. The exchange system can include or interact with one or more blockchain nodes connected to the same or different blockchain. The blockchain nodes can be used by the monitoring system, the exchange system, the wallets, and/or any other suitable component. The nodes can be: full nodes, partial nodes (e.g., only synching the most recent blocks of the chain), and/or any other suitable node type.

Each blockchain node is preferably connected to a single blockchain, but can alternatively be connected to different blockchains. The blockchain can be an account-based blockchain (e.g., Ethereum, etc.), a UTXO-based blockchain (e.g., Bitcoin, a Bitcoin fork, Hathor, etc.), and/or any other suitable type of blockchain. The blockchain can execute a blockchain protocol that: validates signatures, validates transactions, and/or performs other functionalities. In an example, the blockchain protocol (e.g., Hathor protocol) can validate a transaction: when the transaction's collective inputs (e.g., input assets and respective amounts) match the transaction's collective outputs (e.g., output assets and respective amounts), when the signature is valid given the transaction information; when the transaction conditions are satisfied; when the inputs (e.g., the input UTXOs) are unspent; when the inputs amounts are sufficient to cover the output amounts; and/or when any other suitable set of conditions are met.

In variants, the signature can be considered valid given the transaction information based on the signature hashtype associated with the signature (e.g., determined based on the sighash flag associated with the signature). For example, when the signature hashtype indicates that all inputs and outputs were used to generate the signature (e.g., is SIGHASH_ALL), the signature is considered valid when the blockchain protocol determines that the signature was generated based on all inputs and outputs (e.g., using CHECKSIG). In another example, when the signature hashtype specifies the set of input and output indices that were used to generate the signature (e.g., is SIGHASH_BITMASK or SIGHASH_RANGE), the signature is considered valid when the blockchain protocol determines that the signature was generated based on the identified inputs and outputs (e.g., using a modified version of CHECKSIG). In another example, when the signature hashtype specifies that a set of transaction conditions were used to generate the signature, the signature is considered valid when the blockchain protocol determines that the signature was generated based on the transaction conditions, and/or that the transaction satisfies the signed transaction conditions. However, the signature can be otherwise considered valid.

However, the blockchain protocol can be otherwise configured. However, the blockchain node can be otherwise configured.

The wallet of the exchange system functions to custody assets. The wallet can custody assets by storing a set of private keys, tracking the assets held by addresses associated with the set of private keys, and/or otherwise custodying assets. The wallet can be executed on: a user device, a platform, and/or any other suitable computing system.

The wallet can have atomic swap support, multi-token support, decentralized exchange integration, interoperability, cross-platform support, smart contract interaction ability, security authentication(s), user-interface(s), real-time market data for better decision-making strategies, and/or wallet backup and recovery options.

The wallet can be online (e.g., “hot”), offline (e.g., “cold”), and/or be operable between any other suitable set of states. Online wallets can be: connected to the Internet, exchange system, or another network; store private keys in a decrypted state (e.g., in a form that can be used to generate signatures); and/or be otherwise configured. Offline wallets can be: disconnected from the Internet, exchange system, or another network; store private keys in an encrypted and/or sharded state (e.g., in a form that cannot be used to generate signatures); and/or be otherwise configured. Wallets can switch between the online and offline states: manually (e.g., upon user request), automatically (e.g., at a predetermined time, when the exchange system requests a signature, etc.), and/or at any other suitable time.

The wallets can generate one or more signatures using the associated private keys. A signature can be mathematically generated from the message being signed (e.g., more preferably a hash of the message being signed, but alternatively other representations of the message) and a private key, or be otherwise generated. The signatures are preferably generated according to a cryptographic signature algorithm, but can be otherwise generated. The signature algorithm is preferably an elliptic curve digital signature algorithm (e.g., ECDSA), but can alternatively be RSA, DSA, EdDSA, RSA with SHA, ECDSA with SHA, and/or any other suitable algorithm.

The message being signed is preferably transaction information but can alternatively be any other suitable message. All or part of the information from a transaction can be used to generate the signature (e.g., be included in the message hash that is used to generate the signature). The set of transaction information that is used to generate the signature can be specified by a signature hashtype, or otherwise identified. Examples of signature hashtypes that can be used include: SIGHASH_ALL, wherein the signature is generated from all inputs and outputs of the transaction; SIGHASH_ALL|ANYONECANPAY, wherein the signature is generated from a single input (e.g., the signor's input) and all outputs of the transaction; SIGHASH_NONE|ANYONECANPAY, wherein the signature is generated from a single input (e.g., the signor's input) and no outputs; SIGHASH_SINGLE|ANYONECANPAY, wherein the signature is generated from a single input (e.g., the signor's input) and the output with the same index; a new sighash type, such as SIGHASH_BITMASK, wherein the signature is generated from the set of inputs and outputs identified in the bitmask (e.g., the inputs and outputs having the indices indicated in the bitmask); a new sighash type, such as SIGHASH_RANGE, wherein the signature is generated from the set of inputs and outputs identified in the input and/or output index ranges; and/or any other suitable set of signature hashtypes. An identifier for the signature hashtype (e.g., a flag) can optionally be added to the signature, wherein the signature validation protocol (e.g., blockchain protocol) can use the identified signature hashtype to determine the portions of the transaction information to evaluate when validating the signature, or otherwise used. However, signatures can be otherwise generated.

However, the wallets can be otherwise configured.

The cryptographic assets (e.g., “assets”) function as digital tokens that can be exchanged for other tokens, other assets, services, and/or any other suitable commodity. The assets can be UTXO-based assets, account-based assets, or any other suitable type of asset. The cryptographic assets are preferably compatible with the blockchain protocol used by the exchange system (e.g., Hathor protocol, etc.), but can alternatively be incompatible with the blockchain protocol. The cryptographic assets can be from a single blockchain, be from multiple blockchains, or from any other suitable blockchain. The cryptographic assets can be native assets, non-native assets (e.g., wrapped assets), and/or any other suitable assets. Examples of assets that can be used include: Hathor, Bitcoin, Ethereum, Litecoin, Tether, USDC, Dogecoin, Algorand, wrapped versions thereof, and/or any other suitable set of assets.

However, any other suitable set of assets can be used.

However, the exchange system can be otherwise configured and/or be used with any other suitable set of components.

However, the blockchains can have any other suitable set of components.

### 4. Method

As shown in FIG. 3, variants of the method for cryptographic asset exchange can include: receiving a set of orders S100, matching the orders S200, and executing the trade S300. The method can optionally include: associating addresses with user accounts S80, monitoring the addresses and/or UTXOs S120, and/or other processes.

All or portions of the method can be performed by the exchange system disclosed above, or be executed by another system. All or portions of the method can be performed in real time, iteratively, concurrently, asynchronously, periodically, and/or at any other suitable time. All or portions of the method can be performed automatically, manually, semi-automatically, and/or otherwise performed.

Receiving a set of orders S100 functions to receive bids and/or asks from user accounts. The orders are preferably received by the order book but can alternatively be received by the execution system and/or by any other suitable component. The orders can be: manually generated (e.g., by a user specifying the order information, selecting the asset identifiers, etc.), automatically generated (e.g., by a trading program, etc.), and/or otherwise generated. The orders can be received: upon order submission, after order validation (e.g., after user ownership of the assets is verified), and/or at any suitable time. The orders are preferably received from a user account, but can alternatively be sent by third party system, automatically generated (e.g., by the exchange system), and/or be otherwise constructed.

An order can include: a spent asset type (e.g., asset type that the respective order is spending), a spent asset identifier (e.g., the specific asset that the respective order is spending, such as the UTXO identifier; the address that the respective order is spending from, such as an Ethereum address; etc.), the spend amount (e.g., the amount of the spent asset to transfer), the spend address (e.g., account holding the spent asset, wherein the private key associated with the spend account is used to sign the transaction), the change amounts (e.g., the amount of assets remaining after transferring the spend amount, such as the remaining UTXOs from the input UTXOs after the order is completed), the change address (e.g., the user's account(s) to send to the change to), the received asset type (e.g., the secondary asset that the spend asset is being exchanged for), the received amount (e.g., the amount of secondary asset to receive in exchange for the spend amount of the spend asset), the receiving address (e.g., the user account(s) to send the secondary asset to; can be the same or different from the change account or spend account), the blockchain fee limit, trade fees, an order identifier, and/or any other suitable information.

In variants, the order can optionally include a set of transaction conditions. Examples of transaction conditions include: an order validity duration (e.g., a requirement to fill the order or kill after one day, week, given block height, or other predetermined time period), an input limit (e.g., limiting the number of UTXO inputs in the transaction used to fulfil the order), an order limit (e.g., limiting the number of orders used to generate the full transaction used to fulfill the order), a partially signed transaction limit (e.g., limiting the number of partially signed transactions that can be aggregated to construct the full transaction used to fulfill the order), a bitmask count limit (e.g., limiting the number of bitmasks that can be associated with the full transaction used to fulfill the order), a spend quantity limit, a per-bitmask length limit, and/or any other suitable transaction condition. In variants, the order can additionally include a partial transaction (e.g., a blockchain transaction including all or some of the order information), a cryptographic signature (e.g., a partial signature generated using all or some of the order information), and/or other information. Additionally or alternatively, the order can be a partial transaction, be a signed partial transaction, and/or be otherwise constructed. However, the order can include any other suitable information. In a first variation, S100 includes receiving an order identifying a spend account, a spend asset, a spend amount, a received asset, a received amount, optionally a receiving address, optionally a change amount, transaction information (e.g., blockchain fee, etc.), a set of transaction constraints, and/or other information. In a first embodiment, the order can identify specific assets (e.g., specific UTXOs) to include in the transaction. In a second embodiment, the order does not identify specific assets (e.g., specific UTXOs) to include in the transaction, wherein the UTXOs are selected after order matching. The order can optionally be signed by the private key of the spend account and/or a private key associated with the user account. The signature is preferably not a valid transaction signature (e.g., the blockchain would not transfer assets based on the order signature), but can alternatively be a valid transaction signature.

In a second variation, S100 includes receiving an order including the information from the first variation and can additionally or alternatively include a set of partial transactions and/or other information. The partial transaction can include values for all fields associated with the ordering user and can optionally include values for a portion of the fields associated with the other party (e.g., the asset type and asset amount transferred to the ordering user), or omit values for the opposing party's fields (e.g., all or some of the fields, such as the opposing party's spend UTXOs and addresses). The partial transaction can optionally include a signature from the ordering user (e.g., from the private key of the ordering user) (e.g., such that the partial transaction is a presigned partial transaction, or partially signed transaction), or omit a signature. The signature is preferably a valid transaction signature (e.g., the blockchain transfers assets based on the order signature), but can alternatively be an invalid transaction signature. The signature is preferably generated based on the values for the ordering user's fields, and can optionally be generated based on the values for the set of transaction constraints, the included values for the opposing party's fields, and/or other information. In a first example, the signature is generated based only on the values for the ordering user's fields (e.g., the ordering user's inputs and outputs) and the transaction constraints. In this example, the signature can be generated using a bitmask (e.g., SIGHASH_BITMASK), wherein the bitmask can select for the bits associated with the ordering user (e.g., the ordering user's input and/or output indices). In a second example, the signature is not generated based on the opposing party's field values (e.g., the opposing party's inputs and/or outputs). However, the signature for the partial transaction can be otherwise generated. In this variant, the signature can optionally be verified by: public key, proof, and/or any other suitable method.

In a first embodiment of the second variation, the order includes a partial transaction in addition to the order information.

In a second embodiment of the second variant, the partial transaction functions as the order, wherein the exchange system can extract the order information (e.g., spend amount, spend asset, etc.) from the partial transaction information.

Each order can include one or more partial transactions. Different transactions in each order can differ in: the selected UTXOs, the spend asset, spend amount, addresses (e.g., receiving addresses, change addresses, etc.), and/or otherwise differ. Alternatively, they can be the same. When one partial transaction in an order is used (e.g., matched with another order, used to construct a full transaction, to construct a full transaction that is validated on-chain, etc.), the other partial transactions in the order can remain pending or be invalidated (e.g., based on user preferences, a set of rules, etc.).

However, the order can be otherwise constructed, and/or any other suitable information can be received as the order.

Receiving the set of orders S100 can optionally include verifying the balance of the spend account identified in the order S120 (e.g., monitoring the address), which functions to verify that the spend account holds enough assets to cover the order. Monitoring the address and/or UTXOs S120 can be executed for all users, only addresses that have registered with the database, or be otherwise executed. Monitoring the address and/or UTXOs can be executed before receiving the order, after receiving an order, after matching orders, or be otherwise executed. The address and/or UTXOs can be monitored by: analyzing the blockchain, aggregating a set of transactions associated with the address and/or UTXO, and determining a balance based on the set of transactions; retrieving the balance of the address and/or UTXO off a data source (e.g., the blockchain, a third-party monitoring system); and/or otherwise determining the balance of the address and/or UTXO. The balance of the spend account is preferably verified based on block information from the blockchain associated with the account (e.g., determined from a node synchronized with the blockchain), but can additionally or alternatively be otherwise verified. The balance of the spend account can be determined: before the order is received (e.g., updated in real-time when new blocks are confirmed); after the order is received; and/or at any other time. Additionally or alternatively, the state of a UTXO identified in the order can be verified (e.g., as unspent) in a similar manner (e.g., monitoring the UTXO). An order is preferably permitted on the order book after spend account and/or UTXO balance verification, but the order can additionally or alternatively be admitted before and cancelled when the spend account and/or UTXO is illiquid, or be otherwise treated. A spend account can be considered liquid when the total value of outstanding orders associated with the spend account remains below the spend account balance, when the total value of outstanding orders associated with the spend account remains below a margin balance, and/or when any other suitable condition is met. A UTXO can be considered liquid when the UTXO is unspent, and/or when any other suitable condition is met.

The method can optionally include associating the user account with a set of addresses S80. The user account is preferably the user account that the order is received from, but can alternatively be an automatically-generated account or another account. The addresses are preferably the addresses identified in the order (e.g., the spend address, the change address, the receiving address, etc.), but can additionally or alternatively be user-provided addresses, addresses associated with the same public key, addresses associated with the same private key, and/or be otherwise determined. Associating the user account with a set of addresses can optionally include verifying address ownership by the user account. Verifying the address ownership can include: sending a message to the user account and validating the resultant signature; sending a test amount of assets to the address and having the user account verify the test amount; validating that the address owns the assets (e.g., the UTXOs) identified in the order; and/or otherwise verifying address ownership. Associating the user account with a set of addresses can optionally include verifying address validity. Verifying address validity can include: cross-verifying the given address with a list of known, valid addresses, or otherwise verifying address validity. However, the user account can be otherwise associated with a set of addresses.

However, S100 can be otherwise performed.

Matching the orders S200 functions to match buy and sell orders (e.g., bids and asks) from the order book. The orders can be matched by the execution system, by the order book, by other users of the execution system, or by any other suitable system. Each order is preferably matched with one other order but can alternatively be matched with multiple orders. The orders are matched after the orders are received (e.g., in S100), but can be matched at any other suitable time. Matching the orders S200 can be accomplished based on FIFO (i.e., first-in, first-out) matching, price-time priority, pro-rata ordering, market-maker priority, discretionary matching, hidden ordering, market-taker models, priority auctions, and/or any other suitable method.

Executing the trade S300 functions to fulfill the matched orders. The trade is preferably executed by the execution system but can alternatively be executed by the order book, by a user device (e.g., when the order book is distributed and the user devices can match and execute trades), and/or any other suitable system. The trade is preferably executed on-chain, wherein the assets are sent from user address to user address and/or are not custodied by the exchange system, but can alternatively be executed off-chain, wherein the assets are sent to the exchange system or another custodian, and the custodian performs the exchange. The trade is preferably executed after the orders are matched (e.g., after S200), but can alternatively be implemented at any other suitable time.

In a first example of executing the trade S300, all the swapping (i.e., transaction) of assets occur on a single blockchain (e.g., Bitcoin, Ethereum, Hathor Network).

In a second example of S300, the transaction and swapping of assets occur on multiple blockchains. In an illustrative example of the second variant, a first user sends an order to swap Bitcoin (BTC) for Ethereum (ETH) and a second user sends an order to swap ETH for BTC. The execution system matches the orders and generates two unsigned transactions (e.g., one for the BTC portion of the trade and another for the ETH portion of the trade), sends both to each user's wallet, and receives signed transactions back. The signed transactions are then sent to the respective blockchains, where the BTC signed transaction is sent to the Bitcoin blockchain and the ETH signed transaction is sent to the Ethereum blockchain.

The transactions can be for the same blockchain (e.g., when the assets are on the same L1 blockchain), different blockchains, and/or any combination of blockchains.

Executing the trade S300 can include: determining trade information for each order S320 and facilitating the trade using the trade information S340, or be otherwise performed.

Determining the trade information S320 functions to determine the information needed to construct the blockchain transaction that executes the trade. The trade information functions to provide all the information needed for a user to send an asset to the opposing party. The trade information is preferably determined from the order information, but can additionally or alternatively be automatically generated by the exchange system, be determined from the partial transaction, be requested from the user (e.g., wherein the UTXOs to use are requested from the user wallet after the match is made), and/or otherwise determined. The trade information can include: the spent asset identifier (e.g., token ID, asset ID, etc.), the spend amount (e.g., the amount being sent to the other party), fees (e.g., network fees, exchange fees, etc.), the spend address (e.g., address holding the spent asset) and/or UTXOs to spend (e.g., transaction ID, index ID, etc.), the other party's recipient address (e.g., a recipient address specified in the other party's order; the spend address specified in the other party's order; etc.), a match identifier, an order identifier, metadata (e.g., a timestamp, nonce, etc.), transaction count limit, bitmask count limit, and/or any other suitable information. However, the trade information can be otherwise determined.

Facilitating the trade using the trade information S340 functions to exchange the assets.

In a first variation of S340, the exchange system generates unsigned transactions that, when signed and confirmed by the blockchain, transfer the assets to the other party after blockchain confirmation. In an example (e.g., shown in FIG. 3), executing the trade can include: generating unsigned transactions S342, sending the unsigned transactions to respective user accounts and/or wallets S346, receiving signed transactions, constructing a unitary signed transaction from the signed transactions S348, and sending the unitary transaction to the blockchain for confirmation S350, wherein confirmation completes the exchange of assets between the parties.

In this variation, the unsigned transactions (e.g., unsigned transaction precursors to the unitary signed transaction) are preferably generated S342 using the trade information, but can be generated using any other suitable information. The trade information can include the order information from the matched orders, a blockchain specification, and/or any other suitable information. Examples of trade information that can be used include: a user address and/or UTXO(s) the user wants to spend, receiving addresses, asset types, asset amounts, a blockchain specifications (e.g., blockchain identifiers), a trade ID, a nonce, a blockchain fee, an exchange fee, and/or any other suitable information. The unsigned transactions can be generated by: the execution system; by a user device of one of the matched users (e.g., wherein the trade information is sent to the user device); by the user devices of all or a subset of the user devices (e.g., wherein the trade information is sent to the user devices); by the matching system (e.g., the system generating the match); and/or by any other suitable system. The unsigned transaction is preferably generated off-chain, but can alternatively be generated on-chain. The unsigned transactions are preferably generated online, but can alternatively be generated offline.

A single unsigned transaction can be generated for the trade, a different unsigned transaction can be generated for each party (e.g., user, user account), and/or any other suitable number of unsigned transactions can be generated. The unsigned transaction is configured to send the spend amount of the spend asset to the other party's recipient address, and can optionally send any change to the sending party's address (e.g., send or recipient address). The unsigned transactions can be for the same blockchain (e.g., when the assets are on the same L1 blockchain), different blockchains, and/or any combination of blockchains.

The unsigned transaction can include a heterogeneous set of tokens (e.g., includes tokens from different blockchains) or a homogeneous set of tokens. In a first example, the unsigned transaction only includes native assets (e.g., assets native to the blockchain, such as BTC for a Bitcoin blockchain, HTR for a Hathor blockchain, ETH for an Ethereum blockchain, etc.). In a second example, the unsigned transaction includes both native assets and non-native assets, wherein the non-native assets can be wrapped (e.g., to be compliant with the blockchain's protocol) or unwrapped. In an illustrative example, the unsigned transaction can trade BTC and ETH for HTR and LTC, where only one of the aforementioned assets is a native asset (e.g., HTR, BTC, etc.). In a third example, the unsigned transaction only includes non-native assets, wherein the non-native assets can be wrapped (e.g., to be compliant with the blockchain's protocol) or unwrapped. However, the unsigned transaction can include any other suitable set of assets.

In a first example, S342 includes generating a single unsigned transaction based on the match (e.g., by the exchange), wherein the single unsigned transaction is sent to the blockchain wallets for signature.

In a second example, S342 includes generating a different unsigned transaction for each blockchain wallet within the match (e.g., by the exchange), wherein each unsigned transaction is sent to the respective blockchain wallet for signature.

In a third example, S342 includes generating a different unsigned transaction by each blockchain wallet (e.g., before a match is made), wherein the blockchain wallet can also sign the unsigned transaction (e.g., using a partial signature, using a bitmask, etc.) before sending the unsigned transaction to the exchange for subsequent matching. Each unsigned transaction is preferably a partial transaction, and includes the trade information from the respective wallet (e.g., one or more: inputs, outputs, user- or wallet-selected inputs, user- or wallet-selected outputs, asset amount spent, asset amount received, spending address, receiving address, etc.), but can additionally or alternatively include trade information from the other party (e.g., be a full transaction).

However, S342 can be otherwise performed.

Sending the unsigned transactions to respective user accounts and/or wallets S346 functions to obtain signatures on the unsigned transaction. Each user account in the match preferably generates at least one signature for the transaction to be considered valid (e.g., by the blockchain). The signatures are preferably generated offchain, but can alternatively be generated onchain. The signatures are preferably generated while the user wallets (e.g., private keys) are online (e.g., “hot”), but can be otherwise generated. In a first embodiment, the entire unsigned transaction is sent to all user accounts in the match, wherein each user account individually generates a signature based on the entire transaction information (e.g., using SIGHASH_ALL). In a second embodiment, the unsigned transaction is serially sent to each user account in the match, wherein each user account signs all or a portion of the transaction (e.g., uses all or their own portions of the transaction information to generate the signature; signs using a SIGHASH|ANYONECANPAY hashtype, etc.). In this embodiment, the last user can sign the entire transaction, and/or only sign part of the transaction. Alternatively, the unsigned transaction can not be sent to the blockchain wallets and/or users. However, the transaction can be signed in any suitable order, and/or the signatures can be otherwise generated.

Receiving signed transactions functions to obtain a signature for the transaction from each user account involved in the trade. The signed transaction can be received by a centralized system (e.g., the exchange system), a user account involved in the match, and/or by any other suitable system. The signed transaction can be received offchain, but can alternatively be received onchain. The signed transactions can be received within a predetermined period of time from the match or from sending the transaction to the user for signature, or the trade can be cancelled; alternatively, other conditions can be placed on transaction signing. The signature is preferably generated using the user's private key and all or a subset of the (full) transaction information, but can be otherwise generated. In a first example, the signature can be generated for each user from a hash of only the user's inputs, outputs, and private key. In a second example, the signature for each user is generated from a hash of only the user's inputs, outputs, trade constraints, and private key. In a third example, the signature is generated from a set of information consisting essentially of user's inputs, outputs, trade constraints, private key, and transaction identifying information (e.g., partial transaction identifier, nonce, etc.). In a fourth example, the signature is generated based on all transaction information. In a fifth example, the signature is generated based on specified transaction information (e.g., specific transaction indices, values, etc.; specified by the user, by the exchange, by the other user, etc.). However, the signature can be otherwise generated.

The method can optionally include verifying if the signature on a partial transaction is valid and/or if the aggregated transaction is valid. The execution system and/or any other suitable system can receive the bitmask from a user and a signed partial transaction. The bitmask-indicated inputs and outputs can be verified as indeed relevant to the user to ensure the user and/or wallet are not signing on assets of others. If the test fails, the signature is invalid. If verified, the hash of the transaction with the bitmask appended to the header can be computed and compared against the signature provided by the user. If matched, the signature on the partial transaction can be deemed valid. Any other suitable verification strategies can be executed as well. The aggregated transaction can also be verified as valid if the execution system and/or any other suitable system can sign the aggregated transaction combining the partial signatures confirming that the signatures are valid for each of the partial transactions merged. In this variant, the signed transaction can be posted on the blockchain. In another embodiment, the aggregated transaction may be a multi-signature transaction wherein the transaction requires the signatures of each participating user after the merge to confirm the aggregated transaction is indeed valid (i.e., leaving their partial transaction untouched). The execution system and/or any other suitable system can send the unsigned aggregated transaction to each user and obtain each respective signature before the execution system may optionally sign as well and post on the chain. Posting on chain would be impossible without the signatures of the participating users as, in this embodiment, the transaction is multi-signature.

Constructing a unitary signed transaction from the signed transactions S348 functions to aggregate the unitary transaction that executes an atomic on-chain swap (e.g., the atomic trade). The unitary transaction preferably exchanges at least a first amount of a first asset (e.g., UTXO asset) for a second amount of a second asset (e.g., account-based asset wrapped in a UTXO, etc.) between a first and second blockchain wallet (e.g., user), respectively, but can alternatively include any other suitable transaction. The unitary transaction preferably includes signatures from both blockchain wallets (e.g., both users' private keys, etc.), but can alternatively include signatures from a single wallet, include additional signatures (e.g., from the exchange, from the order book, etc.), and/or include any other suitable set of signatures. The first and second exchanged assets are preferably heterogeneous (e.g., different), and can be from different blockchains, but can alternatively be homogeneous (e.g., the same), and can be from the same blockchain. The first and second assets can be of the same type (e.g., UTXO assets, account-based assets, non-UTXO-based assets, etc.) or of different types. The assets can be native (e.g., native tokens, native to the blockchain confirming the transaction, performing the atomic swap, etc.), non-native, and/or otherwise related to the blockchain. Non-native assets can be wrapped (e.g., to be compatible with the blockchain's protocol), or unwrapped.

S348 can include: aggregating the signatures with the unsigned transaction (e.g., unsigned full transaction), aggregating (pre)signed partial transactions, and/or otherwise constructing the unitary transaction.

In a first example, S348 includes adding (e.g., appending, associating, etc.) the signatures to the unsigned transaction. In a second example, S348 includes aggregating the signed transactions received from each user. However, S348 can be otherwise performed. Alternatively, a different signed transactions can be constructed for different blockchains (e.g., when swapping between different native tokens on the respective native blockchains). S348 is preferably performed offchain, but can alternatively be performed onchain.

Sending the unitary signed transaction to the blockchain for confirmation S350 functions to execute the trade. The unitary signed transaction can be sent by: the system constructing the unitary signed transaction, a centralized system, a user device (e.g., the user device constructing the unsigned transaction, the last user wallet to sign the unitary transaction, etc.), a third party system, and/or any other suitable system. The unitary signed transaction is preferably sent after S348, but can be sent piecemeal or at any other suitable time. S350 preferably includes sending the unitary signed transaction to the blockchain (e.g., Hathor network) and/or blockchains (e.g., two or more blockchains) via a node for the respective blockchain, but the unitary signed transaction can be otherwise sent to the blockchains.

Once the unitary signed transaction is sent to the blockchain(s), the respective blockchain(s) preferably validate the signed transaction based on the blockchain's protocol (e.g., by the blockchain's nodes, using the blockchain's consensus mechanism, etc.), wherein signed transaction validation sends the assets to the respective addresses (e.g., executes the trade). Validating the signed transaction can be executed by a single blockchain such as the Hathor Network, and/or by any other blockchain if the atomic swap is transacting between different chains (e.g., Ethereum network, Bitcoin network, and/or any other suitable blockchain network). Validating the atomic transaction can be executed after the signatures from users have been aggregated and posted to a blockchain, but can otherwise be implemented. Validating the atomic transaction can include sending a signed atomic transaction to a blockchain, wherein the signed transaction is the atomic transaction composed by the execution system, user wallet, and/or any other suitable system. Validation also can include verifying the signed atomic transaction is valid by cross-verifying that all the signatures of required parties (e.g., participating users and/or wallets) have with sufficient funds for each party. The blockchains can validate the signed transaction when: the aggregate input values match the aggregate output values (e.g., the same total number of tokens of each type are input and output by the transaction); the signatures match the transaction information (e.g., the signature is valid given the public key associated with each input's user account and the signed field values of the transaction, as indicated by a SIGHASH flag or other indicator attached to the transaction); the transaction constraints are satisfied (e.g., less than the maximum number of orders, private keys, inputs, outputs, addresses, and/or other parameter is involved in the transaction); and/or otherwise considered valid. Since the unitary signed transaction includes all the information for the trade, the trade (e.g., asset transfer between the user accounts) is preferably atomic upon transaction validation (e.g., completed within one block, completed within one validation, completed in a single step, etc.); alternatively, the trade can be a multi-step trade (e.g., when different portions of the trade are executed on different blockchains, when an initial asset transfer needs to be validated before a secondary asset transfer is initiated, etc.). However, the blockchain can otherwise validate the signed transaction.

In an illustrative example of the first variant, the system can construct a first and second unsigned transaction for a first and second user, respectively. The first unsigned transaction is configured to send a first amount of a first asset from a first set of UTXOs owned by the first user to a recipient address of the second user. The second unsigned transaction is configured to send a second amount of a second asset from a second set of UTXOs owned by the second user to a recipient address of the first user. Both unsigned transactions can include a common match identifier (e.g., unique match identifier). Each unsigned transaction can specify the input UTXOs specified by the sending user's order, a first output transferring the spend amount of the spend asset to the recipient address of the other user, optionally a second output transferring the fees to an exchange address, optionally a third output transferring a remainder of the spend asset (e.g., the input UTXO amount, less the spend amount and fees) to an address of the sending user, and/or other information. The first and second unsigned transactions are sent to the first and second users for signature by their respective private keys, and the signed versions are received in return. The signed transactions can be received by the system, optionally matched to confirm that both parties have signed (e.g., based on the match identifier), optionally verified (e.g., wherein the signatures are verified), sent to the blockchain (e.g., the Ethereum network), and confirmed.

In a second illustrative example of the first variant, the system can construct a single unsigned transaction (“transaction proposal”) for the trade, wherein the transaction is configured to send a first amount of a first asset from a first set of UTXOs owned by the first user to a recipient address of the second user and send a second amount of a second asset (e.g., the same or different from the first asset) from a second set of UTXOs owned by the second user to a recipient address of the first user. The unsigned transaction is then sent to both users, wherein each user signs the transaction (and/or their respective UTXOs) using their respective private keys. The signed transactions (and/or signatures) are received from the users, optionally aggregated (e.g., appended together, hashed, otherwise attached to the transaction), and sent to the blockchain (e.g., Hathor network) for confirmation; alternatively, the signed transaction can be directly sent to the blockchain for confirmation.

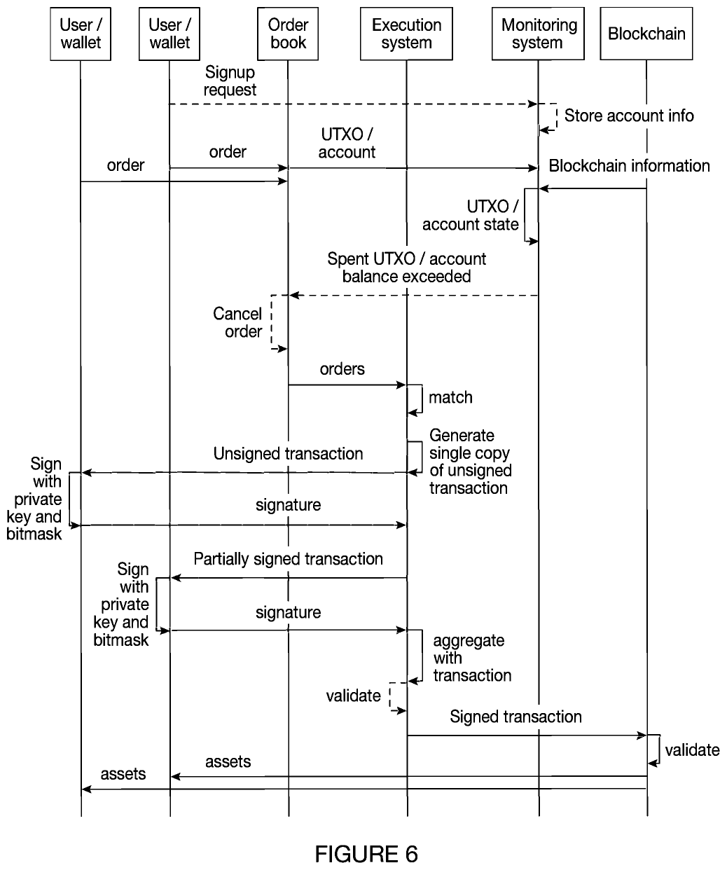

In a third illustrative example of the first variant, the system can construct a first and second unsigned transaction for a first and second user, respectively (e.g., an example is shown in FIG. 6). A unique unsigned transaction is generated for each user before any orders have been matched (e.g., after the orders are received). The first unsigned transaction is configured to send a first amount of a first asset from a first set of UTXOs owned by the first user for a desired amount of a second asset. The second unsigned transaction is configured to send a second amount of the second asset from a second set of UTXOs owned by the second user for a desired amount of the first asset. Each unsigned transaction can specify the input and output UTXOs, preferably utilizing a bitmask to specify the desired input and outputs, wherein the bitmask is a mask of Boolean values (i.e., 1 and 0) imposed over some data such that the Boolean values enable the selection to include certain elements and exclude others in the partial transaction but can be otherwise specified. In an illustrative example, the transaction information can be masked using the bitmask, and the remaining information (e.g., included information) is included in the signature generation hash (e.g., with the private key). The first and second unsigned transactions are sent to the first and second users for signature by their respective private keys, and the signed versions are received in return. In this variant, each signed transaction is a partially signed transaction, as the signature only is confirming the user-indicated input and output UTXOs—not necessarily all the input and output UTXOs needed in the full transaction. The partially signed transactions can be received by the system, optionally matched to confirm that both parties have signed (e.g., based on a match identifier), optionally verified (e.g., wherein the signatures are verified to indicate the signature correctly represents the partial transaction specified by each user), aggregated into one signed transaction, and sent to the blockchain (e.g., the Ethereum network), and confirmed.

In a fourth illustrative example of the first variant, the exchange system and/or any other suitable system can perform a Hathor atomic swap to complete the exchange. In this example, a first user and a second user both utilize input and output UTXOs to exchange transaction data (i.e., perform an atomic swap). In this variant, the swap can be executed with only one on-chain transaction. The first user and the second user both have wallets and can establish an off-chain communication channel including email, Telegram, Discord, and/or any other suitable channel. The first user and second user can negotiate a transaction proposal, call the generation of one or more unsigned transactions and/or unsigned partial transactions by S342 and S344, respectively, and receive the transactions by S346 through a wallet application feature and/or otherwise called. This can all be done off-chain. The first user and the second user can sign the transaction(s) and send the signature(s) and/or transaction(s) to an off-chain execution system, but can be otherwise sent. The signed transaction(s) and/or signature(s) can be received by the execution system, optionally matched to confirm that both parties have signed (e.g., based on a match identifier), optionally verified (e.g., wherein the signatures are verified to indicate the signature correctly represents the partial transaction specified by each user), and aggregated into one signed transaction—all executed off-chain, or otherwise completed. The signed transaction can be sent to the blockchain (e.g., the Hathor network) S350, and confirmed on-chain.

In a first embodiment of the first variant, a transaction can be associated with an expiration time. If a user does not provide the signature over the transaction (or partial transaction) within an hour, a day, and/or any suitable predetermined time period, the trade can be cancelled, the message invalidated, the signatures and/or signed transactions not aggregated or posted to the blockchain(s), and/or the trade can be otherwise managed.

In a second embodiment of the first variant, the exchange system and/or any other suitable system can receive one or more unsigned transactions directly from wallets. The signed transaction can be cancelled and/or invalidated if certain conditions are not met, including the wallet not sending the signed transaction within a predetermined expiration time. The transaction (i.e., message) can be signed by the wallet using a private key (i.e., secret key), a proof, and/or any other suitable signature mechanism.

However, the first variant can be otherwise performed.

In a second variant of S340, the exchange system can send the trade information to the respective parties, wherein the parties can independently execute their side of the trade. For example, when the assets are on the same blockchain (e.g., the same L1 blockchain), the exchange system can send the order information (e.g., order ID, spend amount, etc.), the opposing party's recipient address, and a smart contract address (e.g., an atomic swap smart contract address) to each party, wherein each party sends the spend amount to the smart contract, and the smart contract releases the assets to the opposing party when a set of conditions are met. Alternatively, the exchange system can construct unsigned transactions sending the spend amount to the smart contract and calling the contract functions for the users. In another example, the parties can use an HTLC to complete the exchange.

In a third variant of S340, the exchange system and/or any other suitable system can utilize a hashed timelock contract (HTLC) to complete the exchange for a cross-network order. In an illustrative example, a first user can send a first amount of a first asset of a first network (i.e., blockchain) to the HTLC contract. The first user, the contract, and/or any other suitable system can generate a secret key as well as a hash of the secret key. When the first user sends the first amount of the first asset of the first network to the contract, the hash of the secret key is sent to a second user. The second user can use the hash of the secret key to deposit a second amount of a second asset of a second network to the contract. Doing so can allow the first user to use the secret key to redeem the second amount of the second asset of the second network deposited by the second user. Thereafter, the contract unlocks, and the secret key is made known to the second user. The second user then can redeem the first amount of the first asset of the first network deposited by the first user, thereby completing the swap. The contract can send the assets to the participating users if a set of conditions are met and/or can send assets otherwise. The contract returns the assets to the sends if the set of conditions are not met and/or can return assets otherwise.

In a fifth variant of S340, the execution system and/or any other suitable system can aggregate presigned partial transactions. This can enable the trade to be completed (e.g., a unitary signed transaction to be generated and broadcast to the blockchain) without requiring the users' wallets (e.g., private keys) to be online (e.g., while the users wallets are offline). Since the signatures for the partial transactions are already valid, a new signature does not need to be generated after the signed partial transactions (i.e., orders) are matched. This variant can be completed by the execution system, the matching system, and/or any other suitable system. This variant can be completed while the users' wallets are offline (e.g., the private keys are in cold storage or otherwise offline), be performed while the users wallets are online, and/or be performed agnostic to the user wallets' states. This variant can include: generating partial transactions S344, signing the partial transaction S346, constructing a unitary signed transaction from the signed transactions S348, and sending the unitary signed transaction to the blockchain for validation S350.

In this variant, the partial transactions are preferably generated by the user accounts submitting the orders (e.g., in S100), but can be generated by the exchange system (e.g., based on the user-submitted order), and/or otherwise generated. The partial transactions are preferably generated before the orders are submitted, but can alternatively be generate after order submission, after order matching, and/or at any other suitable time. The partial transactions are preferably those described in the second variant of S100, but can alternatively be any other suitable partial transaction.

In a first embodiment, generating a partial transaction S344 can be done by the wallet utilizing the user's order information and/or transaction details.

In a second embodiment, generating a partial transaction S344 can be done by utilizing the bitmask to specify desired inputs and outputs by applying a bitmask (i.e., comprising Boolean values) over the transaction to generate a partial transaction that can then be signed by the user.

In the fifth variant, signing a partial transaction S346 functions to allow a user to verify the relevant inputs and outputs of a transaction and confirm their approval of the transaction. This can be done by the user, wallet, and/or any other suitable system after the transaction is generated and sent by preferably the execution system but can be otherwise generated and sent. The partial transaction is preferably signed by the respective user account before submitting the orders (e.g., in S100), but can alternatively be signed before the orders are matched, after the orders are matched, and/or at any other suitable time.

Each user preferably independently signs their part of the transaction (e.g., signs a partial transaction), wherein the signed parts of the transaction differ between each user in the match. Alternatively, the signatures can be based on the opposing partys' transaction information (e.g., based on overlapping information). The signature (e.g., partial signature) is preferably generated using a bitmask, but can be otherwise generated. The bitmask can specify the bits of transaction information to include in the partial signature (e.g., the desired input and outputs, the transaction constraint information to include in the signature, etc.), but can be otherwise configured.

In an embodiment of the fifth variant, generating a signature for a partial transaction S344 can be done using a bitmask, wherein the bitmask selects a subset of the transaction information from the transaction that matters to the signor (i.e., use a bitmask to mask out bits of the transaction template or message), and can optionally indicate that the signature is validating a partial transaction and not a full transaction. The bitmask, along with the other parts of the transaction data and/or parameters, are hashed (i.e., using a secret key) to become the signature. The signature can be hashed using a signature hash flag (i.e., sighash) which functions as a small part of each input in a transaction that determines which parts of the transaction become immutable once a signature has been added to the transaction. In a specific example, the bitmask can include a mask of Boolean values (i.e., 1 and 0) imposed over the transaction data, such that the Boolean values enable the inclusion of a subset of elements and the exclusion of other elements in signature construction, but can be otherwise specified. The elements selected by the bitmask can be: elements with values (e.g., filled-out transaction fields), fields associated with the user account (e.g., associated with the private key), and/or any other suitable element. In an illustrative example, the transaction information can be masked using the bitmask, and the remaining information (e.g., included information) is included in the signature generation hash (e.g., with the private key).

In an example, the transaction information in the subset of included elements can include the signor's inputs and sending address, the signor's output (e.g., change) and receiving address, optionally a set of transaction parameter values, and/or any other information. When the transaction information includes the set of transaction parameter values, the signature can be deemed invalid if the set of transaction parameter values change during the period after a trade is initiated and the before the transaction is posted on a blockchain. The blockchain can determine whether the set of transaction parameter values match the signed transaction parameter values when validating the transaction.

The bitmask and/or element information (e.g., included element indices or bits, excluded element indices or bits, etc.) can be attached to the signature (e.g., as cleartext, using a flag, etc.), such that the blockchain protocol can use the same bitmask to validate the partial signature, be included in the transaction, or excluded from the transaction. Alternatively, the signed partial transaction information can be indicated using a header, identifying the inputs and outputs the signor is signing. The inputs and outputs may be numbered, lettered, or otherwise delineated. In this embodiment, the signor appends an array of indicators that map which inputs and outputs are being considered for the signature to the header. These indicators can be numerical, textual, and/or any other suitable representation for the inputs and outputs—not necessarily a bitmask in this embodiment. The transaction including the appended header can be hashed, and the signature (i.e., the hash) can be sent back to preferably the execution system but can otherwise be executed.

Alternatively, the bitmask can be a predetermined bitmask (e.g., wherein the blockchain protocol only permits a single bitmask configuration), be generated de novo by the blockchain validators (e.g., based on the information associated with a given user), and/or be otherwise identified for signature validation. However, the partial signature can be otherwise generated.

In the fifth variant, constructing a unitary signed transaction from the signed transactions S348 functions to aggregate the partially signed transactions from matched orders into a single, unitary transaction (e.g., atomic transaction). In this variant, since the signatures on the partial transactions are independently valid, the signatures (and associated partial transactions) can simply be aggregated together into a valid unitary transaction (e.g., wherein the set of signed partial transactions satisfies a set of valid transaction conditions), without any additional signing or validation. This can enable each user to sign just for the inputs and outputs that are relevant to the respective user, without needing to be online to wait for other signors to complete the transaction.

In the fifth variant, sending the unitary signed transaction to the blockchain can be performed in a similar manner to the first variant, but can be otherwise performed. In this variant, the blockchain can consider a transaction valid when the partial signatures match the information in the partial transactions (e.g., indicated by the bitmask, header, or other partial transaction information indicator) cooperatively forming the unitary signed transaction (e.g., the blockchain independently validates the signatures against their respective partial transactions), and/or otherwise validate the unitary signed transaction.

In a sixth variant, S340 is performed similarly to the first variant, except constructing a unitary signed transaction from the signed transactions S348 includes combining the signatures of the partial transactions into a signed full transaction. This can be accomplished by the execution system after the partial transactions are signed and sent from a user to the execution system, but can be otherwise implemented. The partial transactions used in this variant can generated in a similar manner to that described in the fifth variant, or be otherwise generated.

In a first embodiment of the sixth variant, the execution system and/or any other suitable system can keep track of each partial transactions it receives and match a valid pair of partial transactions wherein the valid pair of partial transactions have an equal aggregated input asset amount to aggregated output asset amount.

In a second embodiment of the sixth variant, the execution system and/or any other suitable system can issue unitary transactions with more than one pair of partial transactions and can maximally aggregate as many partial transactions together wherein the underlying condition of aggregated input assets equal aggregated output assets is met, and the partial transactions count limit in the aggregated transaction is not surpassed. The second embodiment would limit the number of posts on chain.

In any of the embodiments within the sixth variant, the partial transactions can also be appended together and hashed again by the execution system and/or any other suitable system, re-signing the merged transaction as one. Proof that the merged transactions were validly aggregated (and/or were aggregated by a trusted source) can additionally or alternatively be shown using a proof of knowledge or other mechanism. This can be accomplished using zero-knowledge proofs, SNARKS, or an otherwise appropriate proof of knowledge.

However, the exchange can be performed in any other suitable manner.

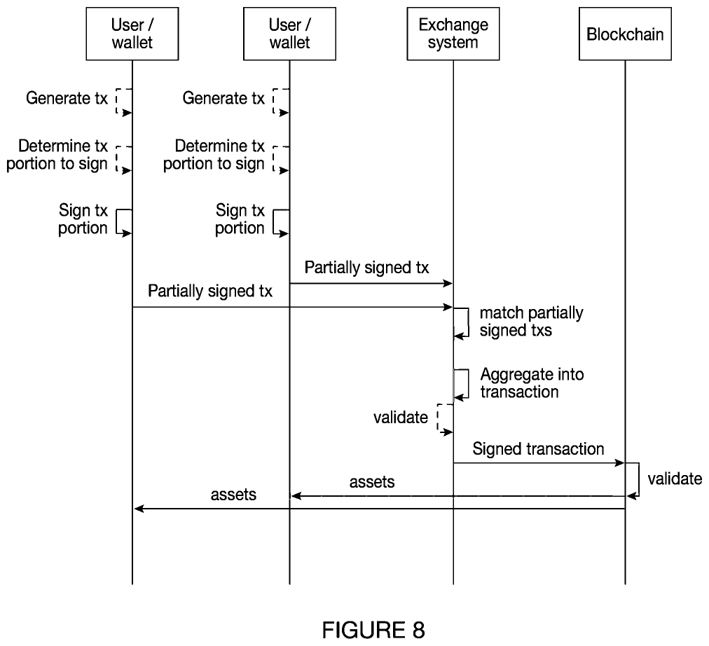

In a first example, the method includes: constructing one or more unsigned transactions (uTx) for each order (e.g., based on the respective order information) and sending the unsigned transaction to the user accounts (e.g., that placed the respective orders in the matched order set) for signature by the respective private keys. In variants, this can be performed by the execution system, or by another system. The unsigned transaction (“transaction proposal”) is preferably compliant with the spent asset's protocol or blockchain but can alternatively be otherwise constructed. Each unsigned transaction can include: the spent asset identifier (e.g., asset that the respective order is spending), the spend amount (e.g., the amount of the spent asset to transfer), the spend account (e.g., account holding the spent asset, wherein the private key associated with the spend account is used to sign the transaction), the other party's recipient address, a match identifier (e.g., for the matched order set), an order identifier, exchange and/or transaction fees, and/or other trade information (e.g., example shown in FIG. 8). The signed transactions (sTx) can optionally be received from the user accounts, wherein the validity of the signatures are validated, optionally aggregated into a unitary transaction (e.g., a Hathor transaction, wherein the signed transactions form different components of a Hathor transaction's inputs; a Hathor atomic swap; etc.), and sent the signed transactions to the blockchain (e.g., the Hathor blockchain) and/or the respective assets' blockchains (e.g., for the spent assets). Alternatively, the users (e.g., their wallets) can send the signed transaction to the respective blockchains.

In a second example, the method can include: sending the trade information to the respective parties, wherein the parties can use an external system (e.g., smart contract) to settle the trade. For example, the execution system can send the trade information and a smart contract address (e.g., for an atomic swap smart contract, HTLC, etc.) to the respective parties, wherein the respective parties construct and sign transactions transferring the respective assets to the smart contract. The smart contract can then release the assets (e.g., send the assets) to the opposing parties when a set of exchange conditions (e.g., the assets are received from both parties) are met. Alternatively, the execution system can construct the transactions to send the assets to the smart contract.

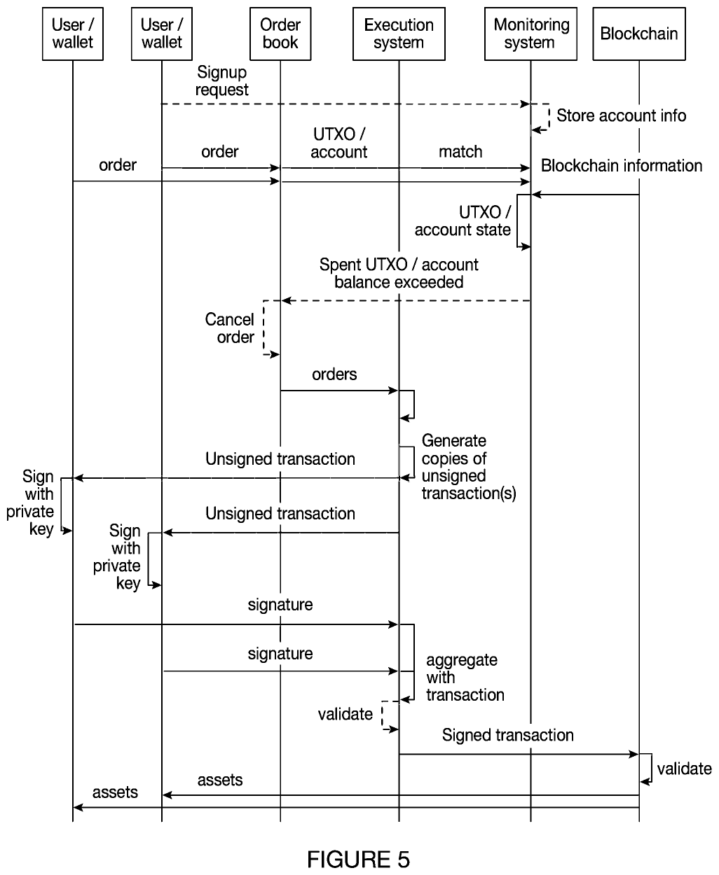

In a third example, the method can include: constructing one unsigned transaction (uTx) for each order (e.g., based on the respective order information), wherein the unsigned transaction are serially sent to the user accounts (e.g., that placed the respective orders in the matched order set) for signature by the respective private keys. An example is shown in FIG. 5. The unsigned transaction (“transaction proposal”) is preferably compliant with the spent asset's protocol or blockchain but can alternatively be otherwise constructed. The unsigned transaction is can include: the spent asset identifier (e.g., asset that the respective order is spending), the spend amount (e.g., the amount of the spent asset to transfer), the spend account (e.g., account holding the spent asset, wherein the private key associated with the spend account is used to sign the transaction), the other party's recipient address, a match identifier (e.g., for the matched order set), an order identifier, exchange and/or transaction fees, and/or other trade information (e.g., example shown in FIG. 8). In this variant, the unsigned transaction is sent to a first user, wherein the first user signs the transaction. The first user can sign: only the portions of the transaction associated with the first user, the entire transaction (e.g., using SIGHASH_ALL), or any other suitable portion of the transaction. When the first user only signs portions of the transaction associated with the first user, the first user can sign: a single input (e.g., the first user's UTXO input) and all outputs (e.g., using SIGHASH_ALL|ANYONECANPAY); a single input (e.g., the first user's UTXO input) and no outputs (e.g., using SIGHASH_NONE|ANYONECANPAY); a single input and the output with the same index (e.g., SIGHASH_SINGLE|ANYONECANPAY); one or more inputs and one or more outputs (e.g., any number of inputs having any index value and/or any number of outputs having any index value; using a new SIGHASH_BITMASK hashtype, wherein the bitmask enables the user to select the set of inputs and outputs to sign, or using a new SIGHASH_RANGE hashtype, wherein the range specifies the range of inputs and/or outputs to sign; etc.); and/or any other suitable portion of the transaction. In a specific example, a user can selectively sign one or more inputs and one or more outputs of the transaction using a bitmask to specify the desired input and outputs, wherein the bitmask can include a mask of Boolean values (i.e., 1 and 0) imposed over the transaction data (e.g., input and output indices), that selectively include and exclude transaction data elements in the signature hash. Alternatively, the set of inputs and outputs to sign can be manually selected by the user, automatically selected by the wallet (e.g., using a set of rules, such as automatically selecting all inputs and outputs associated with the private keys managed by the wallet), and/or otherwise determined. A flag (e.g., SIGHASH_BITMASK), the mask itself, and/or other information can be included in the signature. This information can be used by the blockchain protocol to validate the signature (e.g., validate that the signature is valid for the given input and/or output indices). The partially signed transaction (e.g., signed by the first user) can then be sent to a second user for signature (e.g., by the first user, by the execution system, etc.). The second user can then sign the entire transaction (e.g., all inputs and outputs, such as by using SIGHASH_ALL), or selectively sign portions of the transaction (e.g., portions of the transaction associated with the second user, such as by using the methods disclosed above). The validity of the signatures can optionally be verified, the signed transactions can be aggregated into a unitary transaction (e.g., a Hathor transaction, wherein the signed transactions form different components of a Hathor transaction's inputs; a Hathor atomic swap; etc.), and the unitary signed transaction can be sent to the blockchain (e.g., the Hathor blockchain) and/or the respective assets' blockchains (e.g., for the spent assets) for validation. Alternatively, the last user (e.g., their wallet) can send the signed transaction (e.g., signed by all users of the matched orders) to the respective blockchains.

In a fourth example, the method can include: constructing one or more unique unsigned transactions (uTx) for each order (e.g., based on the respective order information) and sending the unsigned partial transaction to the user accounts (e.g., that placed the respective orders in the matched order set) for partial signature by the respective private keys. An example of this variant is shown in FIG. 6. In this variant, each signed transaction is a partially signed transaction, as the signature is only based on a portion of the overall transaction. The partially signed transactions (sTx) can be received from the user accounts (e.g., by the execution system, one of the user accounts, another system, etc.), the validity of the signatures can optionally be verified, the partially signed transactions can be aggregated into a unitary transaction (e.g., a Hathor transaction, wherein the signed transactions form different components of a Hathor transaction's inputs; a Hathor atomic swap; etc.), and the signed unitary transaction can be sent to the blockchain (e.g., Hathor blockchain) and/or respective blockchains (e.g., for the spent assets) for validation. Alternatively, the users (e.g., their wallets) can send the signed transaction to the respective blockchains.

In a fifth example, the method can include: receiving a set of orders from a set of users, wherein each order can include a partially signed transaction (e.g., a partially signed partial transaction) from a user. When the orders are matched, a full, unitary signed transaction can be automatically constructed from the respective partially signed transactions and sent to the blockchain (or respective blockchains) for validation. An example is shown in FIG. 7. In this variant, the partial transactions and associated signatures can be generated before the orders are matched (e.g., before and/or after the order is submitted), or be generated at any other suitable time. The partially signed transactions can function as the orders themselves, or be separate data objects from the orders (e.g., the orders can include partially signed transactions in addition to other information). In embodiments, this variant can execute matched orders (e.g., execute the atomic swap) even while the order's user, wallet, or private key is offline, since the partial transactions are presigned before order matching, do not require additional signatures after order matching and/or full transaction construction, and are valid blockchain transactions as long as they are paired with another complimentary partially signed transaction (e.g., another signed partial transaction that has enough inputs and/or outputs to complete the transaction). In this variant, each partial transaction can include: a set of spent asset identifiers (e.g., the assets that the transaction is spending), the spend amount (e.g., the amount of the spent asset to transfer), the spend accounts (e.g., accounts holding the spend assets), the change amounts (e.g., the amount of assets remaining after transferring the spend amount), the change accounts (e.g., the user's account(s) to send to the change to), the received asset (e.g., the secondary asset that the spend asset is being exchanged for), the received amount (e.g., the amount of secondary asset to receive in exchange for the spend amount of the spend asset), the receiving address account (e.g., the user account(s) to send the secondary asset to; can be the same or different from the change account or spend account), the blockchain fee limit, trade fees, and/or any other suitable information. The partial transactions can additionally or alternatively include a set of transaction conditions, such as a minimum or maximum number of orders, inputs, or outputs in the full unitary transaction; validation conditions, such as a minimum or maximum transaction validation block height; and/or other conditions. The partial signature can be generated based on all or part of the partial transaction information (e.g., including or excluding the transaction conditions), and can be signed using a bitmask (e.g., using SIGHASH_BITMASK), a user-specified range (e.g., using SIGHASH_RANGE), and/or using any other suitable signing hashtype.

Different subsystems and/or modules discussed above can be operated and controlled by the same or different entities. In the latter variants, different subsystems can communicate via: APIs (e.g., using API requests and responses, API keys, etc.), requests, and/or other communication channels.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method comprising:
determining a unitary signed transaction exchanging a first amount of a first UTXO asset for a second amount of a second UTXO asset between a first and second blockchain wallet, wherein:
the first UTXO asset is different from the second UTXO asset;
at least one of the first UTXO asset or the second UTXO asset comprises a native token; and
the unitary signed transaction comprises a first signature and a second signature from the first and second blockchain wallets, respectively; and
sending the unitary signed transaction to a blockchain, wherein on-chain validation of the unitary signed transaction by the blockchain atomically swaps the first amount of the first UTXO asset for the second amount of the second UTXO asset.

2. The method of claim 1, further comprising sending a false transaction to the first blockchain wallet for signature.

3. The method of claim 2, further comprising notifying the first blockchain wallet of the false transaction after receiving a signature on the false transaction.

4. The method of claim 1, wherein a set of assets, comprising the first UTXO asset and the second UTXO asset, further comprises a non-UTXO-based asset.

5. The method of claim 1, wherein the first signature comprises a hash of a subset of inputs and a subset of outputs from an unsigned transaction precursor to the unitary signed transaction, wherein the subset of inputs comprises at least two inputs from the unsigned transaction.

6. The method of claim 5, wherein the hash of the subset of inputs and the subset of outputs is generated by applying a bitmask over the unsigned transaction.

7. The method of claim 1, wherein the first signature comprises a hash of a set of transaction constraints on the unitary signed transaction, wherein the set of transaction constraints comprises a limit on a number of bitmasks for the unitary signed transaction.

8. The method of claim 1, wherein the first amount of the first UTXO asset, the second amount of the second UTXO asset, and the first and the second blockchain wallet are determined from a first and second order submitted by the first and second blockchain wallet, respectively, wherein the first and second orders are matched by a centralized and off-chain matching system.

9. The method of claim 1, wherein the first UTXO asset and the second UTXO asset are not custodied in a smart contract.

10. A method comprising:
receiving a first presigned partial transaction from a first wallet identifying a first amount of a first asset and a second presigned partial transaction from a second wallet identifying a second amount of a second asset to swap for the first asset, wherein the first asset is different from the second asset and wherein at least one of the first asset or the second asset comprises a native token;
matching the first presigned partial transaction and the second presigned partial transaction, wherein the first presigned partial transaction comprises a first set of inputs and outputs and the second presigned partial transaction comprises a second set of inputs and outputs;
aggregating the first presigned partial transaction and the second presigned partial transaction into a unitary signed transaction; and
sending the unitary signed transaction onto a blockchain, wherein on-chain validation of the unitary transaction by the blockchain atomically swaps the first amount of the first asset for the second amount of the second asset.

11. The method of claim 10, wherein the first presigned partial transaction comprises a first signature generated by hashing the first set of inputs and outputs, and the second presigned partial transaction comprises a second signature generated by hashing the second set of inputs and outputs.

12. The method of claim 11, wherein hashing the first set of inputs and outputs comprises applying a bitmask over an unsigned partial transaction precursor to the first presigned partial transaction.

13. The method of claim 11, wherein hashing the first set of inputs and outputs comprises hashing a set of transaction constraints for the unitary signed transaction.

14. The method of claim 13, wherein the set of transaction constraints comprises a limit on a number of bitmasks for the unitary signed transaction.

15. The method of claim 10, wherein the first set of inputs and outputs comprises a user-selected set of outputs, wherein the user-selected set of outputs forms a subset of outputs from the unitary signed transaction.

16. The method of claim 10, wherein a set of assets, comprising the first asset and the second asset, further comprises at least one of an unspent transaction output (UTXO)-based asset or a non-UTXO-based asset.

17. The method of claim 10, wherein at least one of the first asset or second asset is not custodied by a third party.

18. The method of claim 10, wherein the first presigned partial transaction comprises a first plurality of inputs and the second presigned partial transaction comprises a second plurality of inputs, wherein a first signature for the first presigned partial transaction is generated based on the first plurality of inputs and a second signature for the second presigned partial transaction is generated based on the second plurality of inputs.

19. The method of claim 18, wherein the blockchain validates the unitary signed transaction by independently validating the first signature for the first presigned partial transaction and the second signature for the second presigned partial transaction.

20. The method of claim 11, wherein the first wallet and the second wallet are offline during unitary signed transaction creation.
